(19) United States
(12) Patent Application Publication
(10) Pub. No.: US 2025/0278283 A1
(43) Pub. Date: Sep. 4, 2025

(54) INTEGRATING USER INTERFACE FUNCTIONALITY FROM DISPARATE APPLICATIONS

(71) Applicant: Intuit Inc., Mountain View, CA (US)

(72) Inventors: Casaundra Meyers TAYLOR, Mountain View, CA (US); Saumya PANDEY, Toronto (CA); Melissa Wilk, New York, NY (US)

(73) Assignee: Intuit Inc., Mountain View, CA (US)

(21) Appl. No.: 18/591,788

(22) Filed: Feb. 29, 2024

(51) Int. Cl. G06F 9/451; G06F 8/71; H04L 67/306

(52) U.S. Cl. CPC G06F 9/451; G06F 8/71; H04L 67/306

(57) ABSTRACT

A management application is applied to a user profile and an identifier of a third-party application to generate an object notation data structure (ONDS). The management application is applied to the ONDS to identify a local software module, associated with the third-party application, to coordinate communication between the local software module and the third-party application. A configuration file is received from an integration service. The management application is applied to the configuration file and the local software module to generate a reconfigured software module for facilitating communication between a local program and the third-party application. The reconfigured software module is applied to the ONDS to generate a reconfigured ONDS. The management application is applied to the reconfigured ONDS to modify a user interface of the local program to include a widget operable to control, via the integration service, the third-party application.

### BACKGROUND

Software users may work with multiple software applications in the course of performing online activities. In many cases the multiple software applications are offered or maintained by different companies or organizations. Thus, if a user desires to configure one or more of the software applications, the user will have to open each such software application, or open a website associated with an individual software application. The user then must separately manage each software application.

Some users have expressed a desire to have a single dashboard from which multiple software applications, offered by different companies or organizations, may be configured or operated. Additionally, some companies or organizations may seek to offer interoperability between different software applications. In other words, it may be desirable for software A to be interoperable in some manner with software B, so that the users of both applications may be enticed to use more features of both software applications. However, software A and software B may not be programmed to interact with each other.

Because the different software applications are programmed, maintained, and often hosted by different organizations, there may be no technical means available for permitting a user to operate or configure both software applications from a single dashboard. Thus, a need exists to provide the technical means to permit a user to configure or operate multiple, disparate software applications from a single dashboard.

### SUMMARY

One or more embodiments provide for a method. The method includes

applying a management application to a user profile of a user and an identifier of a third-party application hosted by a remote computing system to generate an object notation data structure that stores data related to the third-party application and the user profile. The method also includes applying the management application to the object notation data structure to identify a local software module associated with the third-party application. The local software module is programmed to coordinate communication between the local software module and the third-party application. The method also includes receiving a configuration file from an integration service programmed to interface with the remote computing system. The method also includes applying the management application to the configuration file and the local software module to generate a reconfigured software module that is programmed to facilitate communication between a local program and the third-party application. The method also includes applying the reconfigured software module to the object notation data structure to generate a reconfigured object notation data structure. The method also includes applying the management application to the reconfigured object notation data structure to modify a user interface of the local program to include a widget operable to control, via the integration service, the third-party application hosted by the remote computing system.

One or more embodiments provide for another method. The method includes applying a management application to a user profile and identifiers of third-party applications hosted by separate remote computing systems to generate an object notation data structure that stores data related to the user profile and the third-party applications. The method also includes applying the management application to the object notation data structure to identify local software modules associated with the third-party applications. Each of the local software modules is uniquely associated with a corresponding one of the third-party applications. The local software modules are programmed to coordinate communication between the local software modules and the third-party applications. The method also includes receiving configuration files from an integration service programmed to interface with the separate remote computing systems. Each configuration file is received from a corresponding one of the third-party applications. The method also includes applying the management application to the configuration file and the local software modules to generate reconfigured software modules that are programmed to facilitate communication between local programs and corresponding ones of the third-party applications. The method also includes applying the reconfigured software module to the object notation data structure to generate reconfigured object notation data structures. The method also includes applying the management application to the reconfigured object notation data structures to modify user interfaces of the local programs to include widgets operable to control, via the integration service, the third-party applications hosted by the separate remote computing systems.

One or more embodiments provide for a system. The system includes a computer processor and a data repository interfacing with the computer processor. The data repository stores a user profile and an identifier of a third-party application hosted by a remote computing system. The data repository also stores an object notation data structure that stores data related to the third-party application and the user profile. The data repository also stores a configuration file received from an integration service programmed to interface with the remote computing system. The data repository also stores a reconfigured object notation data structure. The system also includes a local software module associated with the third-party application. The local software module is programmed to coordinate communication between the local software module and the third-party application. The system also includes a local program executable by the computer processor. The local program includes a user interface and a widget of the user interface. The widget is operable to control, via the integration service, the third-party application. The system also includes a reconfigured software module that is programmed to facilitate communication between the local program and the third-party application. The system also includes a management application configured to execute on the computer processor, the management application programmed, when executed by the computer processor, to generate the object notation data structure. The management application is also programmed to identify the local software module using the object notation data structure. The management application is also programmed to receive the configuration file from the integration service. The management application is also programmed to generate the reconfigured software module using the configuration file and the local software module. The management application is also programmed to generate the reconfigured object notation data structure using the reconfigured software module and the object notation data structure. The management application is also programmed to modify, using the reconfigured object notation data structure, the user interface of the local program to include the widget.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for integrating user interface functionality from disparate applications, in accordance with one or more embodiments.

FIG. 3 shows another system for integrating user interface functionality from disparate applications, in accordance with one or more embodiments.

FIG. 4 shows an in-use example of a system for integrating user interface functionality from disparate applications, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to systems and methods for integrating user interface functionality from disparate applications. The disparate applications may be referred to as “third-party” applications, one or more of the disparate applications may not be under the control of the organization that offers the integration service of one or more embodiments or, if offered by a single organization, the disparate applications may not be compatible. For convenient reference, all such disparate applications may be referred to as “third-party” applications, even if one or more of the applications is programmed, managed or hosted by one organization.

For example, a user may use three third-party applications, all programmed, hosted and maintained by three different organizations. One of the third-party applications is accessible via a web browser, a second of the third-party applications is installed on a local computer and another third-party application operates using a combination of local data or local executable files on the local computer and server-side data or server-side executable files. None of the third-party applications may be accessed or controlled by another of the third-party applications. However, it is desirable to show a single user interface on the local computer (e.g., a “dashboard”) that permits the user to configure, operate or otherwise control all three third-party software applications. In one example, the user may desire the above-described interoperability. In another example, the organization responsible for one of the third-party software applications may desire to offer to users the above-described interoperability.

A technical challenge exists in providing such interoperability. The different software applications may be incompatible with each other (e.g., do not communicate with each other or use mutually incompatible data schema). The different organizations responsible for the different software applications may not desire to expose code or certain software features to competitors, and thus may lock access to desired configuration features of one or more of the third-party applications.

One or more embodiments provide software tools for providing the above-described interoperability. Described herein are an integration service and a management controller that provide the application programming interfaces (APIs) and data integration tools for gathering data from, or granting access to, the third-party applications.

When a user logs in to a dashboard programmed to configure multiple third-party applications, user information is collected. The user information is stored in an object notation data object (e.g., a JAVASCRIPT® object notation (JSON) file). A management controller then uses the object notation data object to identify software modules that are individually configured to interact with a different third-party application. In other words, each third-party application to be configurable or operable via the dashboard has a single software module assigned to aid in handling integration tasks. Each of the software modules is then reconfigured, based on the object notation data file, based on the specific user settings. The reconfigured software modules then provide the programming and APIs that permit a user to remotely configure or control a corresponding third-party application.

In addition, the reconfigured software module may, in turn, be used to reconfigure the object notation data file. The reconfigured object notation data file may be used to modify a user interface of a local program (e.g., the dashboard) to include one or more new widgets. A widget is a button, menu, wheel, etc. displayed on a user interface and operable to cause a software function to be executed (e.g., to press a button on the user interface and cause a change to the user interface, transfer of data, a printer to print, etc.). The new widgets are programmed to effect, or at least initiate, control of the third-party applications.

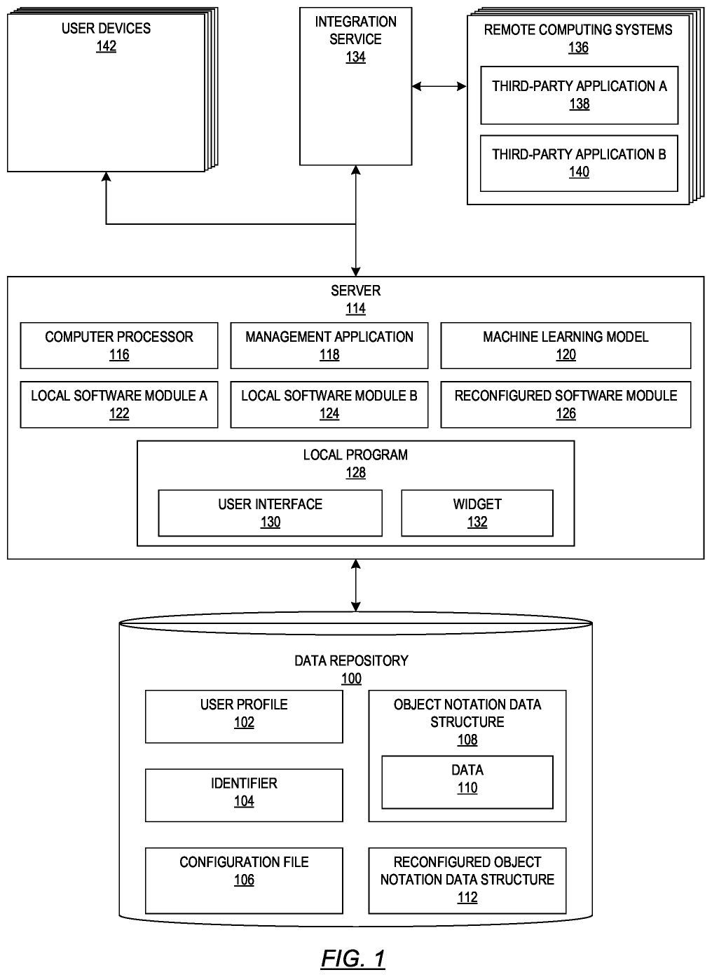

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores one or more user profiles, such as user profile (102). The user profile (102) is a computer readable data structure that stores information about a user of multiple different third-party applications. The user profile (102) may store information such as user identifiers and passwords for the various third-party applications, user demographic information, user settings for the various third-party applications, etc.

The data repository (100) also stores an identifier (104). The identifier (104) is an identifier of one of the third-party applications. While the identifier (104) refers to a single identifier in FIG. 1, the term “the identifier” automatically includes multiple identifiers for multiple third-party applications. The identifier (104) may be stored as part of the user profile (102) or may be stored independently of the user profile (102).

The data repository (100) also may store a configuration file (106). The configuration file (106) is a data structure that stores computer-readable data useful for permitting a computer to configure one or more local software modules, described below, to interact with one or more of the third-party applications. The configuration file (106), for example, may include information for configuring settings for one or more of the local software modules, or may contain instructions or APIs for permitting communication between one or more local software modules and the third-party applications.

The data repository (100) also stores an object notation data structure (108). The object notation data structure (108) stores data (110) related to the one or more of the third-party applications and the user profile (102). In particular, the object notation data structure (108) stores the data (110) in an object notation data structure format. For example, the object notation data structure (108) may be a JAVASCRIPT® object notation (JSON) file. However, the object notation data structure (108) may take the form of other types of object notation data files.

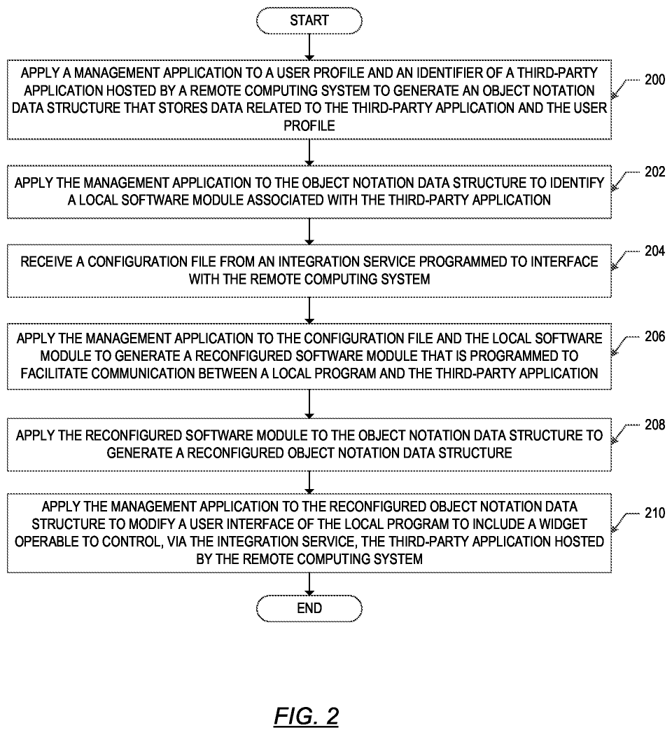

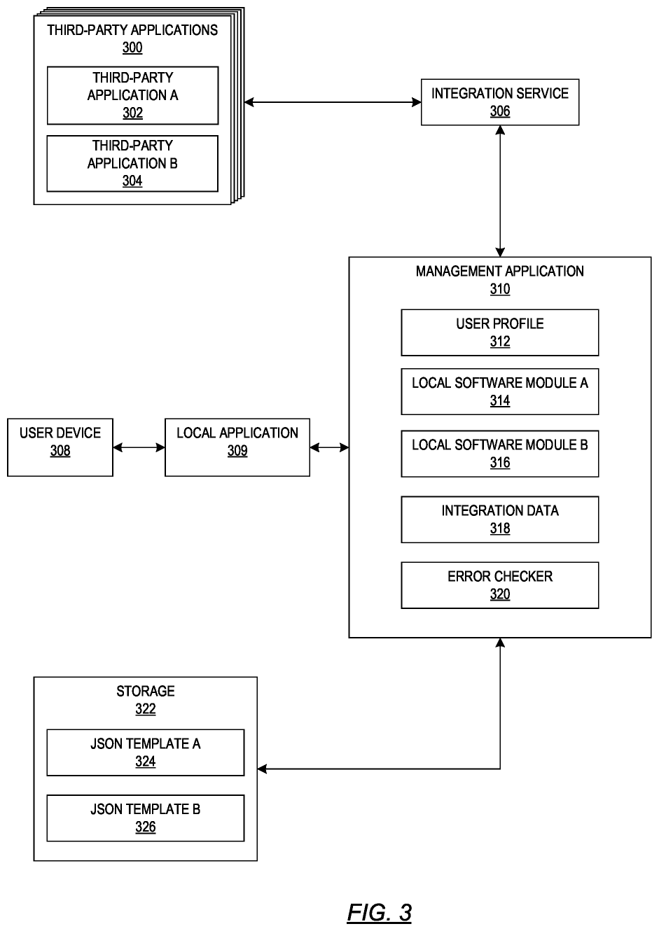

The data (110) may be information retrieved from the third-party applications, the configuration file (106), the user profile (102), or other sources. The data (110) of the object notation data structure (108) also may include pre-programmed information for use during the methods described with respect to FIG. 2 and FIG. 3. For example, the data (110) of the object notation data structure (108) may include an indicator of which local software module may be used to coordinate with a corresponding one of the third-party applications.

The data repository (100) also stores a reconfigured object notation data structure (112). The reconfigured object notation data structure (112) is the object notation data structure (108) after the object notation data structure (108) has been reconfigured. A difference between the object notation data structure (108) and the reconfigured object notation data structure (112) is that the reconfigured object notation data structure (112) includes specific information for permitting the local program or management application (defined below) to interface with one or more of the third-party applications via the local software modules. Generation and use of the reconfigured object notation data structure (112) is described with respect to FIG. 2.

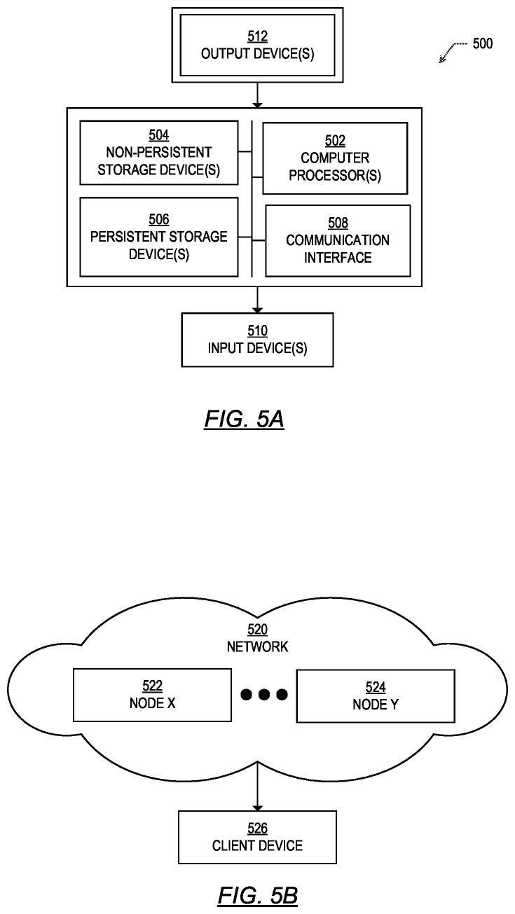

The system shown in FIG. 1 also may include a server (114). The server (114) is one or more computer processors, data repositories, communication devices, and supporting hardware and software. The server (114) may be in a distributed computing environment. The server (114) is configured to execute one or more applications, such as the local software modules and the local program described below. An example of a computer system and network that may form the server (114) is described with respect to FIG. 5A and FIG. 5B.

The system shown in FIG. 1 includes a computer processor (116). The computer processor (116) is one or more hardware or virtual processors which may execute computer readable program code that defines one or more applications, such as the local software modules and the local program described below. An example of the computer processor (116) is described with respect to the computer processor(s) (502) of FIG. 5A.

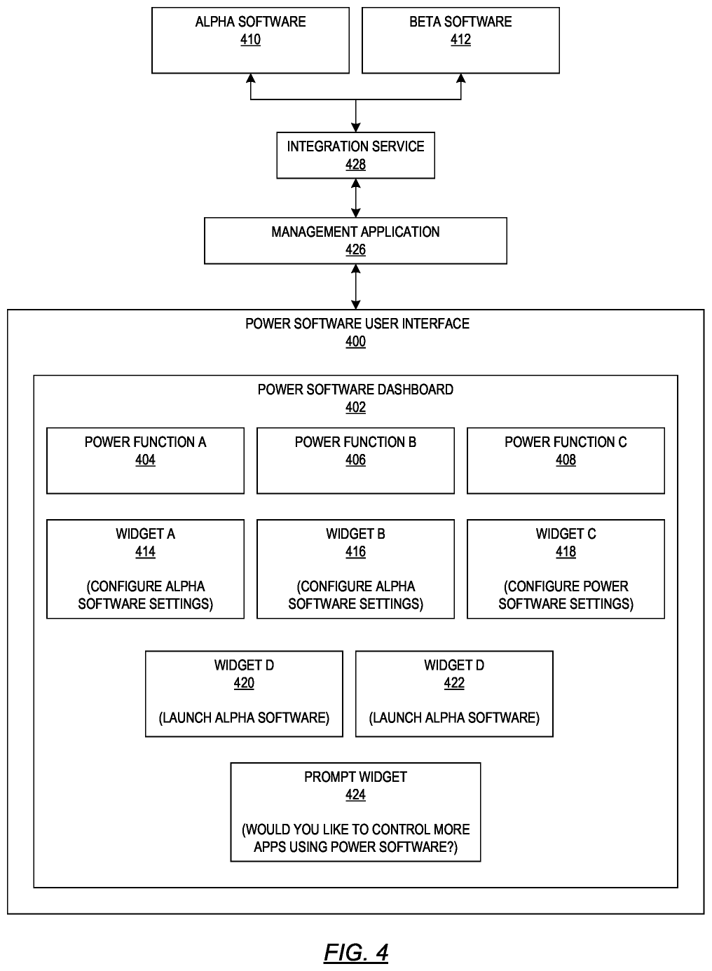

The system shown in FIG. 1 also includes a management application (118). The management application (118) is computer executable program code which, when executed by the computer processor (116), enacts one or computer implemented methods, such as the method described with respect to FIG. 2. The management application (118) also may be the management application described with respect to the examples of FIG. 3 and FIG. 4, and may be programmed to execute the functions described therein.

The system shown in FIG. 1 also includes a machine learning model (120). The machine learning model (120) is one or more computer executable algorithms trained to identify patterns in data, and to output a prediction or a classification with respect to that data. An input to the machine learning model is data of interest, often in the format of a vector data structure. The output, as indicated, is a prediction or classification. With respect to one or more embodiments, the machine learning model (120) may perform a variety of functions, as described with respect to FIG. 2, FIG. 3, and FIG. 4, such as but not limited to identifying which third-party applications a user may be using.

Prior to use, the machine learning model (120) is trained during a training phase. Training involves receiving training data for which the output is known or expected, comparing the actual output of the machine learning model (120) to the known output, generating a loss function based on a difference between the actual output and the known output, and modifying the machine learning model (120) using the loss function. The training process is iterated until convergence. Convergence occurs until a pre-determined difference between the actual output and the known output is less than a threshold number, or until a predetermined number of iterations have occurred. Once convergence is achieved, training stops and the current state of the machine learning model (120) is the version of the machine learning model (120) used during a use, or run-time, phase. Thus, the process of training transforms the initial machine learning model into a final machine learning model, which is different than the initial machine learning model.

The server (114) also may include one or more local software modules, such as the reconfigured object notation data structure (112), the local software module B (124), or the reconfigured software module (126). A local software module is computer executable program code which, when executed by the computer processor (116), executes the functions of a “local software module” as described with respect to FIG. 2, FIG. 3, and FIG. 4. Briefly, a local software module facilitates communication between the management application (118) and one or more of the third-party applications.

In one or more embodiments a single local software module facilitates communication with a single third-party application. Thus, for example, the local software module A (122) may facilitate communication with only the third-party application A (138), defined below. Similarly, the local software module B (124) may facilitate communication with only the third-party application B (140), defined below. Accordingly, the local software modules and the third-party applications may be associated with each other on a one-to-one, or unique, basis.

In other embodiments, a local software module may be programmed to have a one-to-many relationship with multiple third-party applications. Thus, for example, the local software module A (122) may be configured to facilitate communication with both the third-party application A (138) and the third-party application B (140). A one-to-many relationship between the local software modules and the third-party applications may be useful, for example, when the third-party applications are similar or are operated by a common organizational entity.

In still other embodiments, multiple software modules may be programmed to have a many-to-one relationship with a single third-party application. Thus, for example, the local software module A (122) and the local software module B (124) may be configured to facilitate communication with only the third-party application A (138). A many-to-one relationship between the local software modules and the third-party applications may be useful, for example, when the third-party application is complex or has multiple functions.

In yet other embodiments, a many-to-many relationship may exist between the local software modules and the third-party applications. Thus, for example, the local software module A (122) and the local software module B (124) may each be in communication with the third-party application A (138) and the third-party application B (140). A many-to-many relationship between the local software modules and the third-party applications may be useful, for example, when the third-party applications interact with each other during execution.

Nevertheless, it is anticipated that each of the third-party applications is hosted by a different remote computing system which may not communicate with other remote computing systems. Similarly, each of the third-party applications may be programmed and maintained by disparate organizational entities. Thus, in several embodiments the third-party applications and the local software modules may have the one-to-one relationships described above.

The local software modules also may include a reconfigured software module (126). The reconfigured software module (126) is one or more of the local software modules, such as the local software module A (122) or the local software module B (124). The reconfigured software module (126) is a term used to refer to one or more of the local software modules after a reconfiguration step is performed, such as described with respect to step 206 of FIG. 2. Briefly, the reconfigured software module (126) is used to modify an object notation data structure in order to modify a user interface to permit a user to configure a third-party application via a new widget.

The server (114) also may include a local program (128). The local program (128) is computer executable code which, when executed by the computer processor (116), performs a function of interest to the end user. For example, the local program (128) may be a dashboard which contains multiple widgets for controlling the third-party applications. In other words, the local program (128) may be a program which, when executed, generates a user interface that serves as a common control interface for the user.

The local program (128) also may be some other program that executes other functions of the user, such as an online email generation service. In this case, the email generation service may include a configuration function (e.g., a “system settings” widget). The configuration function of the email generation service may then be further configured, using the method of FIG. 2, to configure the third-party applications.

The local program (128) includes a user interface (130). The user interface (130) is a user output device which conveys information to a user via hardware (e.g., a television, touchscreen, monitor, speaker, haptic device, etc.) In many cases the user interface (130) is a display on a computer screen.

The user interface (130) may include a widget (132). The widget (132) is an area of the screen, distinctively marked for user recognition, which is programmed to interact with use input. For example, the widget (132) may be a button, a drop-down menu, a scroll wheel, etc. displayed on the user interface (130).

While FIG. 1 shows a single widget (132), the widget (132) shown in FIG. 1 automatically completes multiple widgets. For example, the widget (132) may include multiple widgets, with each widget programmed to permit a user to configure a corresponding one of the third-party applications. Additionally, the widget (132) may include multiple functions which permit configuration of multiple aspects of a third-party application or which permit configuration of multiple third-party applications.

The system shown in FIG. 1 also includes an integration service (134). The integration service (134) is computer executable program code which, when executed, provides functionality for integrating information received from one or more of the remote computing systems (136), described below, for use of the management application (118). Further use and functions of the integration service (134) are described with respect to FIG. 2. Briefly, the integration service (134) may be used to collect data, receive or retrieve configuration files from one or more of the third-party applications, etc.

The system shown in FIG. 1 shows one or more remote computing systems (136). Each of the remote computing systems (136) are computing systems, possibly similar to the server (114) or the computing system and network environment shown in FIG. 5A and FIG. 5B. However, the term “remote” means that the remote computing systems (136) not considered part of the server (114). The term “remote” may mean that the hardware supporting the server (114) and the remote computing systems (136) may be in geographically different locations. However, the term “remote” may mean that the server (114) and the remote computing systems (136) may be in a similar geographical location, but logically separated from each other.

For example, in an embodiment, the one or more remote computing systems (136) are each maintained by a different third-party entity other than the entity that provides and maintains the server (114) and the various programs on the server (114), such as the local program (128). In this case, the remote computing systems (136) may be deemed “remote” from the server (114).

In another example, one of the remote computing systems (136) is also owned and operated by the same organization that owns and operates the server (114). However, in this case, the remote computing systems (136) in question is logically separated from the server (114). Accordingly, the server (114) may communicate with the remote computing systems (136) in question as if the remote computing systems (136) in question were completely different systems.

The remote computing systems (136) includes one or more third-party applications, such as third-party application A (138) or third-party application B (140). The third-party applications are computer executable program code which perform computer-executed functions. The third-party applications may serve a wide variety of functions which may be different than the local program (128) executing on the server (114).

For example, the third-party application A (138) may be an image editing program, the third-party application B (140) may be a word processor, and the local program (128) may be an email generation program. While the email generation program that is the local program (128) may use the output of the third-party application A (138) (the image editing program) and the third-party application B (140) (the word processor), the organization that owns and operates the local program (128) may not have any direct control over the third-party application A (138) or the third-party application B (140). However, one or more embodiments, as described with respect to FIG. 2, permit a dashboard of the local program (128) to configure the third-party application A (138) or the third-party application B (140).

The system shown in FIG. 1 also shows one or more user devices (142). Each of the user devices (142) are computing systems, possibly similar to the server (114) or the computing system and network environment shown in FIG. 5A and FIG. 5B. However, the user devices (142) are operated by users, such as users of the local program (128) and the third-party applications. The user devices (142) may be devices that are physically or logically distinct from the server (114) or the remote computing systems (136). However, in some embodiments one or more of the user devices (142) may be owned or operated by users belonging to the organization that maintains the server (114) or one or more of the remote computing systems (136). Thus, while the user devices (142) may be entirely different from the remote computing systems (136) or the server (114), in an embodiment one or more of the user devices (142) may be part of the system shown in FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for integrating user interface functionality from disparate applications, in accordance with one or more embodiments. The method shown in FIG. 2 may be executed using the system shown in FIG. 1.

Step 200 includes applying a management application to a user profile of a user and an identifier of a third-party application hosted by a remote computing system to generate an object notation data structure that stores data related to the third-party application and the user profile. The management application may receive, as input, the user profile and the identifier of the third-party application. The management application may retrieve information of interest in the user profile and add the information of interest, together with the identifier, to the object notation data structure file in the appropriate data format of that file. For example, the retrieved information and the user identifier may be added in an appropriate format to a JSON file.

In an embodiment, the user identifier may be identified as part of step 200. For example, step 200 may include applying the management application to the user profile associated with a user login to determine one or more identifiers of one or more third-party applications used by the user and hosted by the remote computing system. The user profile stores the one or more identities, which are retrieved by the management application from the user profile. The management application may then be applied to the user profile and the identifier, as described above.

In another embodiment, a machine learning model may be employed during step 200 to identify the identifier. For example, the input to the machine learning model may be the user profile, after transforming the user profile into a vector. Other information about the user, such as specifications of the user device or information about software usage by the user on the user device, may be added to the vector. The output of the machine learning model may be a prediction of the identities of the third-party applications that the user may wish to configure via the local program. In such an embodiment, the machine learning model may be trained using a training data set for which it is known which third-party applications other users desired to have configuration capability integrated with a local program.

Furthermore, another example, the user may be prompted to input identities of third-party applications which the user desires to be able to configure or manage via the local program. In this case, a prompt may be shown to the user on a user interface of the local program. The prompt requests the user to identify third-party applications which the user wants to be able to configure via the local program.

Yet other examples are possible. Furthermore, combinations of the above examples may be used. Thus, one or more embodiments are not necessarily limited by the examples presented above.

Step 202 includes applying the management application to the object notation data structure to identify a local software module associated with the third-party application. For example, the management application may read the object notation data structure and identify a line within the object notation data structure that specifies the local software module which is to be associated with a given third-party application. In another example, the object notation data structure may include the identities of third-party applications for which configuration capability is to be added to a local program. In this case, the management application may call a library of local programs and match the identities of the third-party applications in the object notation data structure to the identities of local programs contained within the library.

As indicated above with respect to FIG. 1, the local software module is programmed to coordinate communication between the local software module and the third-party application. Also as described above, the local software module may be associated only with the third-party application. However, in other embodiments, the local software module may be associated with multiple third-party applications, or multiple third-party applications may be associated with one or more local software modules.

Step 202 may be extended. For example, step 202 also may include selecting, from among multiple local software modules stored in a data repository, the local software module. Again, the local software module may be uniquely associated with the third-party application.

Step 204 includes receiving a configuration file from an integration service programmed to interface with the remote computing system. As described above, the configuration file may contain instructions for permitting the local program to configure the third-party application via the integration service.

Receiving the configuration file may be performed by the management application calling the integration service to provide the configuration file. The integration service may retrieve the configuration file from a remote computing system that hosts a third-party application, or the integration service may request the remote computing system to send the configuration file. Alternatively, the integration service may build a configuration file for a third-party application, using information provided by one or more of the user profiles, the local software module, the corresponding third-party application, and information from other sources. The built configuration file may include functionality for enabling remote access to the configuration functions of the corresponding third-party application.

Step 206 includes applying the management application to the configuration file and the local software module to generate a reconfigured software module that is programmed to facilitate communication between a local program and the third-party application. For example, instructions for adjusting a user interface may be provided in the configuration file, possibly together with any executable code, executable files, application programming interfaces, passwords, or other information useable to access the figuration settings of the third-party application. The management application may add the user interface instructions to the local software module. Alternatively, the management application may convert the user interface instructions in the configuration file into converted user interface instructions that are compatible with the local program. The converted user interface instructions are then added to the software module assigned to the third-party application in question. The changed software module is referred to as the reconfigured software module.

In a specific example, the management application may add an executable file stored in the configuration file to the local software module. The now reconfigured local software module is thereby able to communicate with the third-party application when a request to configure the third-party application is received via the local program.

Step 208 includes applying the reconfigured software module to the object notation data structure to generate a reconfigured object notation data structure. The revised object notation data structure is referred to as the reconfigured object notation data structure.

Specifically, the reconfigured software module may add, or otherwise revise, new information that was in the reconfigured software module to the object notation data structure. The new information may include one or more of application programming interfaces, executable code, user identifiers, passwords, configuration fields, allowed configuration values, references to data libraries (e.g., images or other types of data), data types and values, etc. The new information in the reconfigured object notation data structure is useful for generating a widget and also providing functionality for the widget. The new information is also useful for permitting configuration of the third-party application from the local program upon actuation of the widget.

Step 210 includes applying the management application to the reconfigured object notation data structure to modify a user interface of the local program to include a widget operable to control, via the integration service, the third-party application hosted by the remote computing system. In an example, the management application may read the reconfigured object notation data structure and extract the new information in the reconfigured object notation data structure. The management application may then modify the local program using the new information.

For example, the management application may add the widget to a user interface of the local program. The management application may add the functionality of the widget to the local program, or may add a reference or link to functionality that permits the user to configure the third-party application upon actuation of the widget.

In a specific example, actuation of the widget may call the remote third-party application itself. The local program user interface then displays the configuration fields, widgets, or values of the third-party application.

In another example, the local program is modified to include functionality for receiving or generating a configuration instruction for configuring the third-party application. In this case, the configuration instruction is transmitted from the local program to the third-party application via the local software application, the integration service, or both.

In yet another example, the local program may call an application programming interface (API) stored in the local software module associated with the third-party application. The API may be programmed to interface with the integration service, which then communicates with the third-party application or the API may be programmed to interface with the third-party application directly. In this example, the configuration instructions received via the user interface of the local program are transmitted to the third-party application via the API (either via the integration service or directly to the third-party application). Other schemes are possible for permitting actuation of the widget to effectuate configuration of the third-party application that is hosted on a remote computing system.

In an embodiment, the method of FIG. 2 may terminate thereafter. However, the method of FIG. 2 may be varied. For example, the method of FIG. 2 may be repeated, either sequentially or in parallel, with respect to multiple third-party applications. In an embodiment each execution of the method of FIG. 2 is performed with respect to a different local software module and an associated different third-party application. In this example, the user interface of the local program may be modified with multiple widgets, each widget operable to configure a different one of the multiple third-party applications. Other variations are possible.

While the various steps in the flowchart of FIG. 2 are presented and described sequentially, at least some of the steps may be executed in different orders, may be combined or omitted and at least some of the steps may be executed in parallel. Furthermore, the steps may be performed actively or passively.

FIG. 3 shows another system for integrating user interface functionality from disparate applications, in accordance with one or more embodiments. The system shown in FIG. 3 is an alternative architecture for implementing the system shown in FIG. 1. Thus, terms common to FIG. 1 and FIG. 3 have similar definitions. The system of FIG. 3 also may be used to implement the method of FIG. 2.

FIG. 3 shows a number of third-party applications (300), including third-party application A (302) and third-party application B (304). In an embodiment, the third-party applications (300) are not part of the system shown in FIG. 3. In other words, the third-party applications (300) may be remote application hosted by a remote computing system not under control of the organization that operates the management application (310), described below. However, in other embodiments, one or more of the third-party applications (300) may be part of the system of FIG. 3, but are considered third-party applications for whatever reason (e.g., the local application (309) is considered logically distinct from the third-party applications (300)).

The third-party applications (300) communicate via an integration service (306) with a management application (310). The integration service (306) is as described with respect to the integration service (134) of FIG. 1 and operates as described with respect to FIG. 2. Briefly, again, the integration service (306) may serve as an intermediary between the third-party applications (300) and the management application (310).

A user device (308), operated by a user, interacts with a local application (309). The local application (309) is part of the system shown in FIG. 3. The user desires to be able to configure one or more of the third-party applications (300) via a user interface of the local application (309), or is offered the capability of doing so. Optionally, the functionality for configuring the third-party applications (300) is automatically added to the user interface local application (309) when the user device (308) logs in to the local application (309).

In any case, the management application (310) is prompted or called to provide the functionality for configuring the third-party applications (300) via the user interface of the local application (309). The management application (310) receives a user profile (312) of the user. The identities of the third-party applications (the third-party application A (302) and the third-party application B (304) in this example) are identified, as described with respect to FIG. 2.

A local software module is uniquely assigned to each of the third-party applications. Thus, the software module A (314) is assigned to the third-party application A (302) and the software module B (316) is assigned to the third-party application B (304).

The management application (310) executes the method of FIG. 2 using the local software modules, as described above. For example, the management application (310) requests the integration service (306) to retrieve, from the third-party applications (300), unique configuration files for each of the local software modules. Alternatively, the integration service (306) may build the unique configuration files, as described with respect to FIG. 2. In any case, the integration service (306) provides the management application (310) with the unique configuration files for each of the third-party applications (300).

Then the management application (310) retrieves, from storage (322) one or more JAVASCRIPT® object notation JSON templates. A JSON template is an object notation data structure that stores pre-determined information in a JSON-specific format. One JSON template is retrieved for each local software module, and hence for each third-party application. Thus, JSON template A (324) is retrieved for use with the local software module A (314) and the third-party application A (302). Similarly, the JSON template B (326) is retrieved for use with the local software module B (316) and the third-party application B (304).

It is possible that a single JSON template may be retrieved for multiple different local software modules. However, the single JSON template is saved into a different file for use with each individual local software module. Thus, again, the local software module A (314) and the local software module B (316) each are assigned a unique JSON file.

The management application (310) then revises the JSON files using the configuration information in the configuration files. The result is reconfigured JSON files, which are examples of the reconfigured object notation data structure (112) described with respect to FIG. 1. Taken together, the reconfigured JSON files store integration data (318), which may be used to modify the user interface of the local application (309) to include widgets which have functionality to permit the user to configure the third-party applications (300) from within the local application (309).

The management application (310) then uses the reconfigured JSON files to reconfigure the local software modules. For example, the management application (310) uses the reconfigured version of the JSON template A (324) to reconfigure the local software module A (314), and uses the reconfigured version of the JSON template B (326) to reconfigure the local software module B (316). The local software modules were already pre-built with data and code for interacting with the local application (309). Thus, the reconfigured local software module A (314) and the reconfigured local software module B (316) each contain the data and programming for permitting the reconfigured local software modules to interact with both the local application (309) and the third-party applications (300). In the latter case, the reconfigured local software modules may interact with the third-party applications (300) via the integration service (306).

Finally, the reconfigured local software modules provide instructions to the local application (309) to modify the user interface of the local application (309) to display one or more widgets. The widgets are operable by the user via the user device (308) to select configuration settings for the third-party applications. Upon a “save” or “execute” command received via the widget of the local application (309), the configuration commands are sent via the reconfigured local software modules to the third-party applications (300) (possibly via the integration service (306)).

The third-party applications (300) are then reconfigured accordingly, as desired by the user. Thus, when the user device (308) later accesses the third-party applications (300), the third-party applications (300) already have been reconfigured as desired by the user even though the user did not directly interact with the configuration settings of the third-party applications (300).

The system shown in FIG. 3 also shows that additional functionality may be provided to the management application (310), relative to the management application (118) of FIG. 1. For example, the management application (310) may include an error checker (320).

The error checker (320) may check for errors in one or more of the JSON files (either a template or a reconfigured JSON file), in the local software modules (either as originally programmed or as reconfigured as described herein), or in the configuration files provided by the integration service (306). If an error is detected, then the management application (310) may take action to correct the error, or at a minimum transmit an error code to the user device (308) via the local application (309) that configuration of one or more of the third-party applications (300) is not possible at that time for whatever reason. If a reason is available, the reason for the failure may be presented to the user via the user interface of the local application (309).

FIG. 4 shows an in-use example of a system for integrating user interface functionality from disparate applications, in accordance with one or more embodiments. The following example is for explanatory purposes only and not intended to limit the scope of one or more embodiments.

A user, Jessica, uses a local program known as “Power Software.” While Jessica is using Power Software, a power software user interface (400) is displayed on a display of Jessica's user device. The power software user interface (400) displays, among other information and widgets, a power software dashboard (402). The power software dashboard (402) shows various widgets that may be used to control the functions of Power Software. The widgets include power function A (404), power function B (406), and power function C (408).

The power functions widgets are unique to Power Software. For example, the widget A (414) is provided with Power Software. When actuated, the widget A (414) calls up one or more dialog boxes to the display screen. The dialog boxes permit Jessica to adjust the settings or configuration of Power Software.

Jessica also uses other software applications while also using Power Software. In this example, Jessica also uses Alpha Software (410) and Beta Software (412). The Alpha Software (410) and the Beta Software (412) are offered and managed by entirely different software companies. Furthermore, the companies that manage Alpha Software (410) and Beta Software (412) are entirely different than the organization that offers and manages Power Software. Thus, without one or more embodiments, if Jessica desires to configure Alpha Software (410), then she must open Alpha Software (410) and use the configuration settings of Alpha Software (410). Similarly, if Jessica desires to configure Beta Software (412), then without one or more embodiments she must open Beta Software (412) and use the configuration settings of Beta Software (412).

However, Power Software offers Jessica the option to configure both Alpha Software (410) and Beta Software (412) via the power software dashboard (402), without opening or otherwise interacting with Alpha Software (410) or Beta Software (412). Specifically, the power software dashboard (402) displays two widgets, widget B (416) and widget C (418). The widget B (416) permits Jessica to configure the settings or configuration of the Alpha Software (410). Similarly, the widget C (418) permits Jessica to configure the settings or configuration of the widget D (420).

Optionally, the power software dashboard (402) may also display other widgets useful with respect to the Alpha Software (410) and the Beta Software (412). For example, the widget D (420) permits Jessica to cause the Alpha Software (410) to launch and execute, possibly with configurations or settings entered using the widget B (416). Similarly, the widget E (422) permits Jessica to cause the Beta Software (412) to launch and execute, possibly with configurations or settings entered using the widget E (422).

The Power Software also includes functionality for adding to the power software dashboard (402) more functional configuration widgets or more functional launch widgets for additional third-party applications. For example, the prompt widget (424), when actuated, generates another dialog box that permits Jessica to specify the identity of another third-party application, not shown in FIG. 4.

Once the identity of the other third-party application is known, the management application (426) may use the identity of the other third-party application together with Jessica's user profile to create a new widget (not shown) for configuring the other third-party application. Additionally, the management application (426) may also add another launch widget to the power software dashboard (402), so that Jessica may launch the other application from the power software dashboard (402).

The operation of the management application (426), possibly in conjunction with an integration service (428), is described with respect to one or more of FIG. 1, FIG. 2, and FIG. 3. Thus, the systems of FIG. 1 or FIG. 4 may use the method of FIG. 2 to generate any of the widget B (416), the widget C (418), or the additional configuration widget described above.

From the above, users may see that one or more embodiments present a number of technical benefits. For example, one or more embodiments may present a live visualization of a connection status (i.e. via the configuration or launch widgets). One or more embodiments may display a dynamic recommendations context by automatically identifying different third-party applications used by the user and presenting the user with options for configuring the third-party applications in a single dashboard. One or more embodiments may provide a dynamic feed of third-party application automations that work with an integration service, without relying on user input. One or more embodiments may provide a dynamic feed of audience segments via various third-party applications based on contacts imported from the third-party applications. In other words, by configuring the settings of a third-party application via a local program dashboard, the contacts of a third-party application may be provided to the local program. One or more embodiments contemplate combinations of the above benefits.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores or micro-cores of a computer processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output devices may be the same or different from the input device(s) (510). The input and output device(s) may be locally or remotely connected to the computer processor(s) (502). Many different types of computing systems exist, and the aforementioned input and output device(s) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
applying a management application to a user profile of a user and an identifier of a third-party application hosted by a remote computing system to generate an object notation data structure that stores data related to the third-party application and the user profile;
applying the management application to the object notation data structure to identify a local software module associated with the third-party application, wherein the local software module is programmed to coordinate communication between the local software module and the third-party application;
receiving a configuration file from an integration service programmed to interface with the remote computing system;
applying the management application to the configuration file and the local software module to generate a reconfigured software module that is programmed to facilitate communication between a local program and the third-party application;
applying the reconfigured software module to the object notation data structure to generate a reconfigured object notation data structure; and
applying the management application to the reconfigured object notation data structure to modify a user interface of the local program to include a widget operable to control, via the integration service, the third-party application hosted by the remote computing system.

2. The method of claim 1, further comprising:
receiving, from a user, a user login to a local computing system hosting the local program; and
applying the management application to the user profile associated with the user login to determine the identifier of the third-party application used by the user and hosted by the remote computing system.

3. The method of claim 1, further comprising:
calling an application programming interface (API) stored in the local software module, wherein the API is programmed to interface with the integration service.

4. The method of claim 1, wherein the configuration file contains instructions for permitting the local program to configure the third-party application via the integration service.

5. The method of claim 1, further comprising:
identifying, prior to applying the management application to the user profile of the user and the identifier of the third-party application, the identifier of the third-party application,
wherein identifying is performed by inputting the user profile to a machine learning model and receiving, as output of the machine learning model, the identifier of the third-party application.

6. The method of claim 1, wherein the local software module is associated only with the third-party application.

7. The method of claim 1, further comprising:
selecting, from among a plurality of local software modules stored in a data repository, the local software module,
wherein the local software module is uniquely associated with the third-party application.

8. The method of claim 1, wherein applying the management application to the configuration file and the local software module to generate the reconfigured software module comprises:
converting user interface instructions in the configuration file into converted user interface instructions that are compatible with the local program.

9. The method of claim 1, wherein applying the management application to the configuration file and the local software module to generate the reconfigured software module comprises:
adding an application programming interface (API) received in the configuration file to the local software module.

10. The method of claim 1, wherein applying the management application to the configuration file and the local software module to generate the reconfigured software module comprises:
adding an executable file stored in the configuration file to the local software module.

11. A method, comprising:
applying a management application to a user profile and a plurality of identifiers of a plurality of third-party applications hosted by a plurality of separate remote computing systems to generate an object notation data structure that stores data related to the user profile and the plurality of third-party applications;
applying the management application to the object notation data structure to identify a plurality of local software modules associated with the plurality of third-party applications, wherein:
each of the plurality of local software modules is uniquely associated with a corresponding one of the plurality of third-party applications, and
the plurality of local software modules are programmed to coordinate communication between the plurality of local software modules and the plurality of third-party applications;
receiving a plurality of configuration files from an integration service programmed to interface with the plurality of separate remote computing systems, wherein each configuration file is received from a corresponding one of the plurality of third-party applications;
applying the management application to the configuration file and the plurality of local software modules to generate a plurality of reconfigured software modules that are programmed to facilitate communication between a plurality of local programs and corresponding ones of the plurality of third-party applications;
applying the plurality of reconfigured software module to the object notation data structure to generate a plurality of reconfigured object notation data structures; and
applying the management application to the plurality of reconfigured object notation data structures to modify a plurality of user interfaces of the plurality of local programs to include a plurality of widgets operable to control, via the integration service, the plurality of third-party applications hosted by the plurality of separate remote computing systems.

12. A system comprising:
a computer processor;
a data repository interfacing with the computer processor and storing:
a user profile,
an identifier of a third-party application hosted by a remote computing system,
an object notation data structure that stores data related to the third-party application and the user profile,
a configuration file received from an integration service programmed to interface with the remote computing system, and
a reconfigured object notation data structure;
a local software module associated with the third-party application, wherein the local software module is programmed to coordinate communication between the local software module and the third-party application;
a local program executable by the computer processor, wherein the local program comprises:
a user interface, and
a widget of the user interface, wherein the widget is operable to control, via the integration service, the third-party application;
a reconfigured software module that is programmed to facilitate communication between the local program and the third-party application; and
a management application configured to execute on the computer processor, the management application programmed, when executed by the computer processor, to:
generate the object notation data structure,
identify the local software module using the object notation data structure,
receive the configuration file from the integration service,
generate the reconfigured software module using the configuration file and the local software module,
generate the reconfigured object notation data structure using the reconfigured software module and the object notation data structure, and
modify, using the reconfigured object notation data structure, the user interface of the local program to include the widget.

13. The system of claim 12, wherein the management application is further programmed, when executed to:
receive, from a user, a user login to a local computing system hosting the local program; and
apply the management application to the user profile associated with the user login to determine the identifier of the third-party application used by the user and hosted by the remote computing system.

14. The system of claim 12, wherein the management application is further programmed, when executed to:
call an application programming interface (API) stored in the local software module, wherein the API is programmed to interface with the integration service.

15. The system of claim 12, wherein the configuration file contains instructions for permitting the local program to configure the third-party application via the integration service.

16. The system of claim 12, wherein applying the management application to the object notation data structure comprises providing the object notation data structure as input to a machine learning model and generating, as output, the identifier of the third-party application.

17. The system of claim 12, wherein the management application is further programmed, when executed to:
select, from among a plurality of local software modules stored in the data repository, the local software module,
wherein the local software module is uniquely associated with the third-party application.

18. The system of claim 12, wherein the management application is further configured such that applying the management application to the configuration file and the local software module to generate the reconfigured software module comprises:
converting user interface instructions in the configuration file into converted user interface instructions that are compatible with the local program.

19. The system of claim 12, wherein the management application is further configured such that applying the management application to the configuration file and the local software module to generate the reconfigured software module comprises:
adding an application programming interface (API) received in the configuration file to the local software module.

20. The system of claim 12, wherein the management application is further configured such that applying the management application to the configuration file and the local software module to generate the reconfigured software module comprises:
adding an executable file stored in the configuration file to the local software module.
